(19) United States
(12) Patent Application Publication
(10) Pub. No.: US 2026/0187958 A1
(43) Pub. Date: Jul. 2, 2026

(54) SYSTEMS AND METHODS OF CONFIGURING AND USING A TRAINED MULTI-TENANT MODEL

(71) Applicant: MCDONALD'S CORPORATION, Chicago, IL (US)

(72) Inventors: Omer AHMAD, Naperville, IL (US); Hannah WILDE, Wheat Ridge, CO (US); Yuefeng ZHANG, Naperville, IL (US); Isidro DE LOERA, JR., Naperville, IL (US); Jose GONZALEZ, Naperville, IL (US)

(21) Appl. No.: 19/225,462

(22) Filed: Jun. 2, 2025

Related U.S. Application Data
(60) Provisional application No. 63/739,461, filed on Dec. 27, 2024.

(51) Int. Cl. G06V 10/22; G06V 10/56; G06V 20/40; G06V 20/52; G06V 40/20

(52) U.S. Cl. CPC G06V 10/235; G06V 10/56; G06V 20/46; G06V 20/52; G06V 40/23

(57) ABSTRACT

Systems and methods that use a trained multi-tenant model are disclosed herein. In an embodiment, a method of using a trained multi-tenant model in a workspace includes receiving a first video feed including a workstation and a second video feed including a completed item station, building a worker utilization inference result queue from a first asynchronous inference thread that runs a human pose estimation model and a clothing color extraction model using sequential frames from the first video feed, building an order tracking inference result queue from a second asynchronous inference thread that runs an object detection model and an item tracking model using sequential frames from the second video feed, and merging the worker utilization inference result queue and the order tracking inference result queue to generate a real-time indication of activity at one or more workstations shown in the first video feed or the second video feed.

### PRIORITY CLAIM

This application claims priority to U.S. Provisional Application No. 63/739,461, filed Dec. 27, 2024, entitled “Systems and Methods of Configuring and Using a Trained Multi-Tenant Model,” the entire contents of which is incorporated herein by reference and relied upon.

### BACKGROUND

### Technical Field

The present disclosure generally relates to systems and methods of configuring and using a trained multi-tenant model. The present disclosure also generally relates to a graphical user interface enabling efficient customization for different workspaces.

### Background Information

In recent years, a proliferation of internet-of-things devices and an increased demand for real-time processing has sparked an interest in edge computing. Edge computing enables faster inference times than sending data to the cloud for analysis. Additionally, deep learning has made strides in domains such as vision, audio and text.

As far as computer vision, there are several known techniques of determining human pose. Human Action Recognition using long-short term memory (LSTM) and convolutional neural networks (CNN) uses both temporal and spatial features to classify human actions. LSTM Pose Machines use a mixture of LSTM and pose estimation to classify human actions. Human Activity Recognition uses 3D convolutional neural networks to capture spatial and temporal features simultaneously. Taxonomy-based approaches use various methods of human action recognition and at the end combine the approaches.

These known techniques create several technological challenges. These models need the full power of an entire graphics processing unit (GPU) or tensor processing unit (TPU), which are expensive, require significant amounts of energy, and exert significant amounts of heat which can reduce the useful life of the components. The training processes for these models can take several weeks or even months, depending on the size of the models and complexity of the datasets, which can further halt research and development time and expand the testing time. Developing and fine-tuning the models can take significant amounts of time and require specialized expertise in machine learning. The datasets can also be very large, and the quality and size of the datasets can impact the performance of the models, with noise and poorly annotated data leading to inaccurate predictions.

These technological challenges are further amplified when deploying computationally expensive deep learning applications in resource-constrained edge environments, particularly in a multi-tenant scenario where more than one deep learning model is running. Co-locating multiple deep learning models on a single GPU comes with complexities that are not present or are less extreme in a single-tenant single-application scenario. Memory constraints arise when multiple models are competing over the same memory and compute because the models require a substantial amount of memory to store their weights, activations and input data. When multiple models are employed on a single GPU, they must all compete for limited memory resources, which leads to slower performance and increased memory usage. Researches have proposed various techniques to alleviate this, such as model quantization, weight pruning and knowledge distillation.

Computational resource contention is another challenge for multi-tenant deep learning applications. Models can experience inter-tenant interference when executing concurrently on the same backend machine, which can cause latency degradation. This becomes worse with more co-located workloads and can degrade the overall application throughput.

### SUMMARY

The systems and methods of the present disclosure provide a multi-tenant model that overcomes the technological challenges of prior methods. The disclosed systems and methods use imagery data in a multi-tenant deployment approach to perform a combination of object detection, human pose estimation and object tracking. The disclosed systems and methods are designed for real-time monitoring and analysis of team member activity and order tracking using live video feeds, utilizing multiple machine learning models on a single GPU for real-time inferences.

The disclosed architecture employs an asynchronous inference thread for processing video frames and generates crew activity metrics for visualization, reporting and taking actions to improve team utilization. The disclosed architecture uses a combination of human pose estimation and color markers to monitor activity levels at user-defined workspaces. The disclosed architecture also uses a specialized graphical user interface (GUI) that can be configured for use in a variety of different workspaces, that visualizes results of the user-defined workspaces, and that provides real-time updates and insights from the deployed multi-tenant model.

A first aspect of the present disclosure is to provide a method of using a trained multi-tenant model in a workspace. The method includes receiving a first video feed of a workstation and a second video feed including a completed item station, building a worker utilization inference result queue from a first asynchronous inference thread that runs a human pose estimation model and a clothing color extraction model using sequential frames from the first video feed, building an order tracking inference result queue from a second asynchronous inference thread that runs an object detection model and an item tracking model using sequential frames from the second video feed, and merging the worker utilization inference result queue and the order tracking inference result queue to generate a real-time indication of activity at one or more workstations shown in the first video feed or the second video feed.

A second aspect of the present disclosure is to provide another method of using a trained multi-tenant model in a workspace. The method includes receiving a first video feed of at least one workstation, enabling a user to designate a workstation region within the first video feed using a polygon, enabling the user to assign a visual identifier to the workstation region, detecting a human object in each of a plurality of frames of the first video feed, determining whether a pose of the human object extends into the workstation region in each of the plurality of frames of the first video feed, extracting a color of the human object in each of the plurality of frames of the first video feed, and determining an activity level in the first video feed based on the human object extending into the workstation region and the extracted color.

A third aspect of the present disclosure is to provide a system for using a trained multi-tenant model in a workplace. The system includes at least one video feed of a workplace from at least one video recording device, a graphical user interface, a graphical processing unit, and a computer processing unit. The graphical user interface is configured to (i) enable a user to designate a workstation region within the at least one video feed using a polygon, (ii) enable the user to designate a line within the at least one video feed which defines when consumer items are considered completed, and (iii) enable the user to assign a clothing color of a team member to the workstation zone. The graphical processing unit is configured to generate results for (a) a first inference result queue storing data regarding whether the team member with the designate clothing color uses a pose crossing into the designated workstation region in a plurality of sequential frames of the at least one video feed, and (b) a second inference result queue storing data regarding whether consumer items cross the defined line in a plurality of sequential frames of the at least one video feed. The computer processing unit is configured to merge the first inference result queue and the second inference result queue and generate a real-time indication based thereon.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 illustrates an example embodiment of a general workspace configured using the multi-tenant model disclosed herein;

FIG. 2 illustrates an example embodiment of a method of configuring the multi-tenant model disclosed herein;

FIGS. 3A, 3B, 4A, 4B, 5A and 5B illustrate example embodiments of a graphical user interface enabling the methods disclosed herein;

FIG. 6 illustrates an example embodiment of a method of using the multi-tenant model disclosed herein;

FIG. 7 illustrates an example embodiment of a human object detection performed during the methods discussed herein;

FIG. 8 illustrates an example embodiment of a human pose estimation performed during the methods discussed herein;

FIG. 9 illustrates an example embodiment of detecting an active human object during the methods discussed herein; and

FIG. 10 illustrate an example embodiment of associating a human pose estimation with clothing color during the methods discussed herein.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

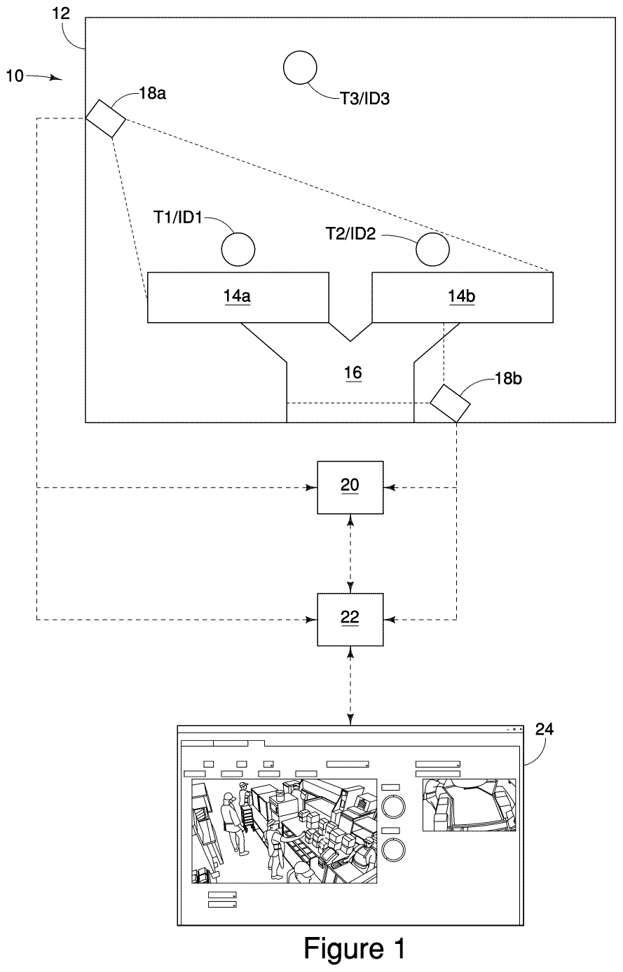

FIG. 1 illustrates an example embodiment of a system 10 configured to utilize a multi-tenant model in accordance with the present disclosure. In FIG. 1, the system 10 is shown for a generic workspace 12 including one or more workstations 14 and one or more completed item stations 16. In the embodiment discussed herein, the workspace 12 is a restaurant kitchen and the workstations 14 are food preparation stations such as a grill station, a fry station, a prep table, and so on, but those of ordinary skill in the art will recognize from this disclosure that the systems and methods described herein can be applied to other industries and activities.

In FIG. 1, a team member T is assigned to run each of the workstations 14. Each team member T wears a visible identifier ID that distinguishes from other team members T. In the embodiments disclosed herein, the visible identifier ID includes a colored vest. Here, a first team member T1 assigned to a first workstation 14a wears vest with a first color identifier ID1, and a second team member T2 assigned to a second workstation 14b wears a vest with a second color identifier ID2. In alternative embodiments, the visible indicators can include particular patterns, other types of clothing, and/or other physical features attributed to the team members T.

In the illustrated embodiment, the system 10 further includes one or more video recording devices 18, a graphics processing unit (GPU) 20, and a central processing unit (CPU) 22. As discussed in more detail below, the GPU 20 and CPU 22 are configured to run one or more asynchronous inference threads using video feeds provided by the recording device(s) 18. The CPU 22 interacts with the GPU 20 to run the asynchronous inference threads and is also configured to generate a graphical user interface (GUI) 24 that enables a user to define and revise the parameters used by the GPU 20 and the CPU 22 when running the asynchronous inference threads.

The video recording devices 18 are configured to record a live video feed of one or more of the workstations 14 and/or one or more completed item stations 16. In FIG. 1, a first video recording device 18a records a live video feed of the first workstation 14a and the second workstation 14b, and a second video recording device 18b records a live video feed of a completed item station 16. The first video recording device 18a is positioned to record a video feed of the first workstation 14a and the second workstation 14b from a generally top left or top right perspective angle. The second video recording device 18b is positioned to record a video feed of the completed item station 16 from a generally top perspective angle. The video feeds are transmitted from the video recording devices 18 to the GPU 20 and the CPU 22 for further use in accordance with the methods discussed herein. One example of a suitable video recording device 18 is a network camera having a minimum of 1080p (Full HD) for clear and video capture, a frame rate of at least 30 frames per second, a wide-angle lens with a field of view of at least 90 degrees to cover a broad area, and support for Ethernet (PoE) for a reliable network connection and power supply.

The GPU 20 is configured to run a multi-tenant model with plurality of deep learning applications in one or more asynchronous inference threads, as described in more detail below. One example of a suitable GPU 20 is a CUDA-compatible GPU with 8 GB VRAM.

The CPU 22 is configured to generate the GUI 24 that enables the multi-tenant model to be used in accordance with the methods described herein. The CPU 22 generally includes at least one processor and at least one memory. As understood in the art, the processor preferably includes a microcomputer with a control program that controls and executes steps of the methods described herein. The processor can also include other conventional components such as an input interface circuit, an output interface circuit, and storage devices such as a ROM (Read Only Memory) device and a RAM (Random Access Memory) device. The RAM and ROM store processing results and control programs that are run by the processor. The memory can include a non-transitory machine-readable storage medium. One example of a suitable CPU 22 is a CPU with four cores and 64 GB RAM.

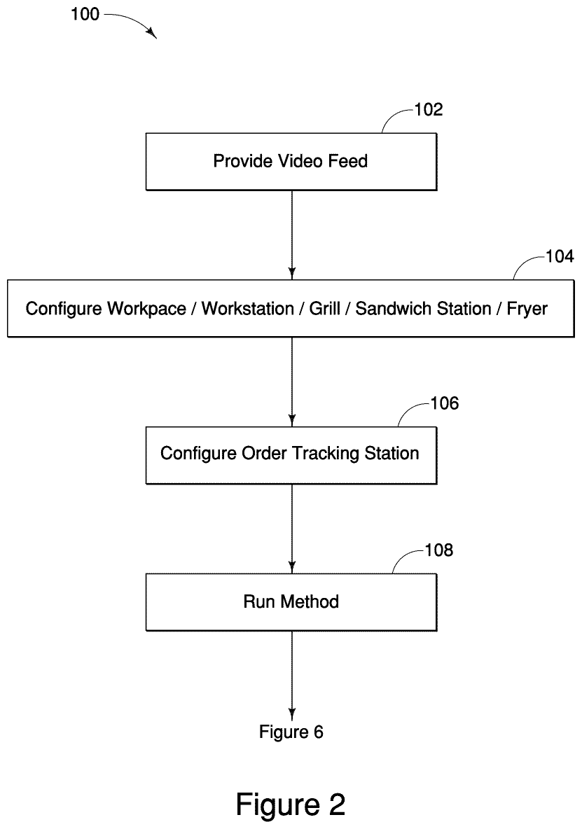

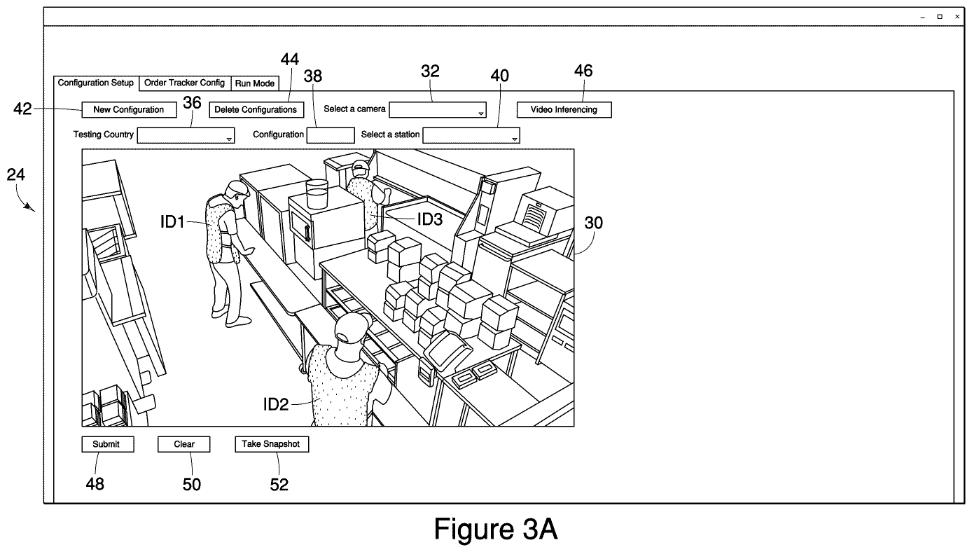

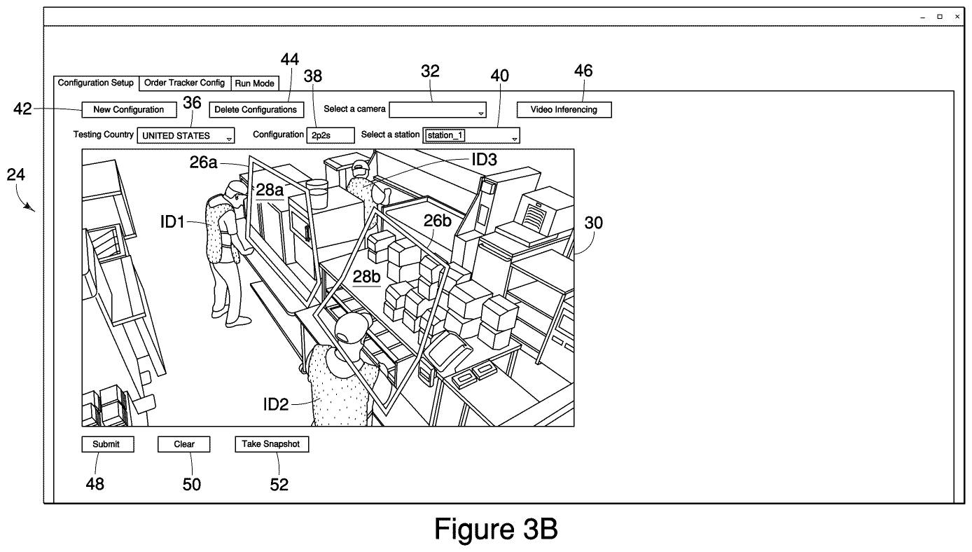

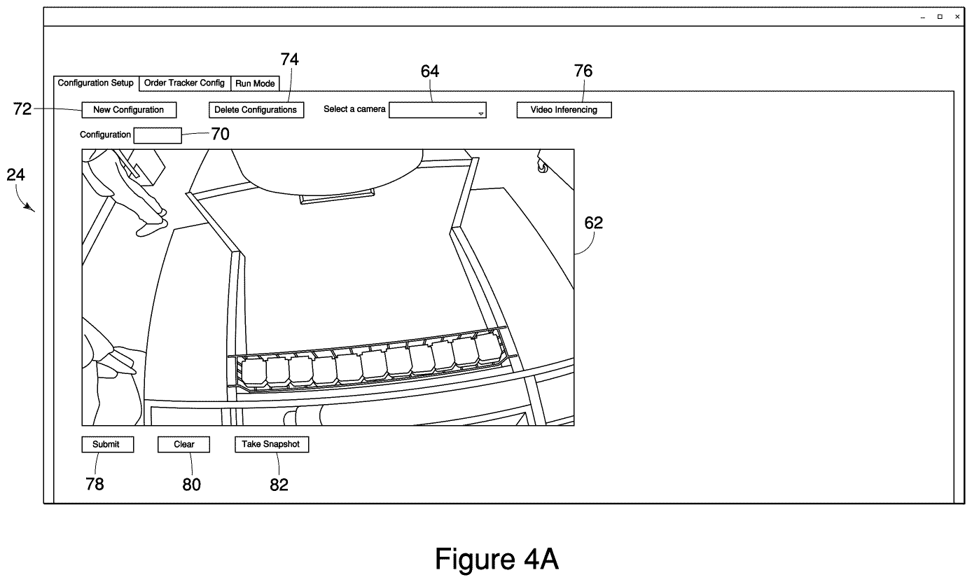

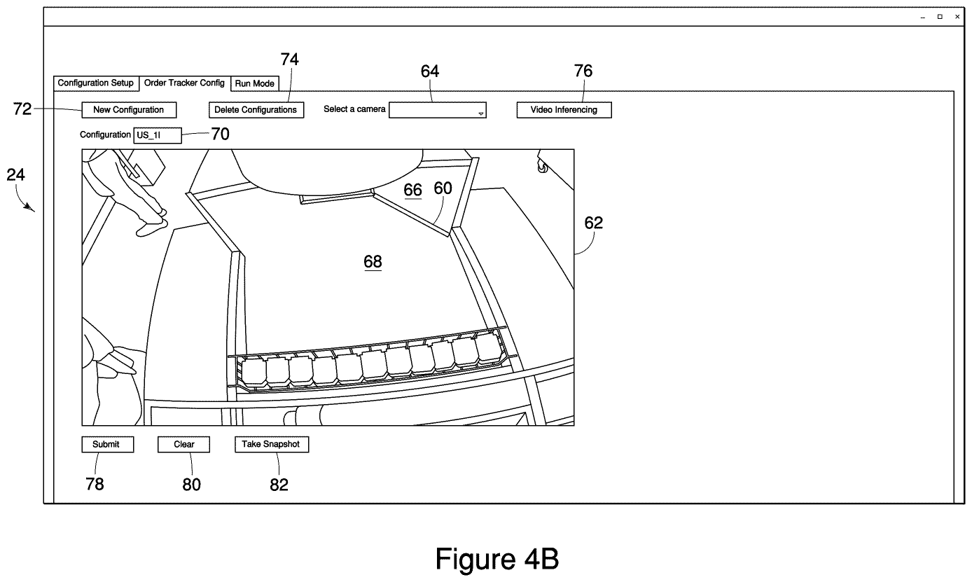

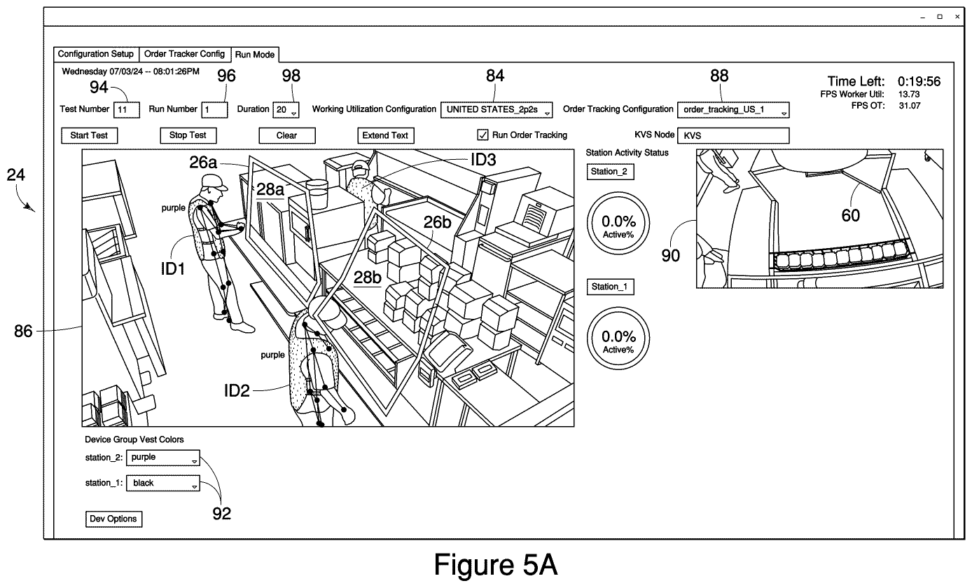

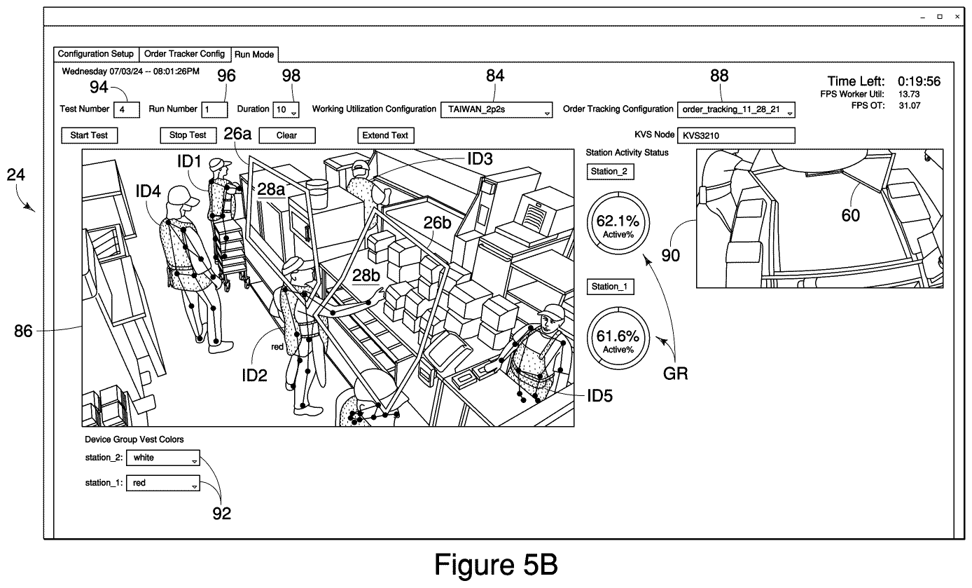

FIG. 2 illustrates an example embodiment of a method 100 of configuring a trained multi-tenant model for a particular workspace 12 using the GUI 24, while FIGS. 3A to 5B illustrate example embodiments of the GUI 24 in a configuration setup mode (FIGS. 3A and 3B), an order tracker configuration mode (FIGS. 4A and 4B), and a run mode (FIGS. 5A and 5B) during the method 100. It should be understood from this disclosure that certain steps of the method 100 can be added, removed or altered without departing from the spirit and scope of the method 100. It should further be understood from this disclosure that certain features of the GUI 24 can be added, removed or altered.

Initially, a workspace 12 including a plurality of workstations 14 is configured for use. At least one video recording device 18 is positioned and arranged in the workspace 12 to provide a video feed from a generally top perspective left-side or right-side view of at least one workstation 14. The same or a different video recording device 18 is also positioned and arranged to record a video feed of at least one completed item station 16 from a generally top perspective angle. The video recording device(s) 18 are operatively connected to the GPU 20 and the CPU 22. Additionally, each of the team members T is provided a vest or other object having a distinctive visible identifier ID.

At step 102, each video recording device 18 provides a live video feed to the GPU 20 and CPU 22. The CPU 22 integrates the live video feed into the GUI 24 so that a user can use the GUI 24 to configure the system 10 as desired based on the set-up of the workspace 12, workstations 14 and completed item stations 16, the user's preferences, and any other factors deemed necessary or beneficial by the user.

At step 104, a user uses the GUI 24 to configure the workspace 12 and/or one or more workstations 14. Initially, the user places the GUI 24 in a configuration setup mode to create and label workstations 14. During configuration setup, the user uses polygons 26 to create and label workstations 14 within the video feed(s). For example, in a restaurant setting, the user can use polygons 26 to create and label workstations 14 as a grill station, a sandwich station, a fry station, a prep table, etc. The GUI 24 enables the user to view one or more video feeds from the video recording devices 18 and overlay a polygon shape over each workstation 14 to identify a workstation region 28. The user can define multiple workstation regions 28 in the same video feed and/or define workstation regions 24 in separate video feeds from multiple video recording devices 18.

FIGS. 3A and 3B illustrate an example embodiment of the GUI 24 in the configuration setup mode. FIG. 3A illustrates the GUI 24 before the user has overlaid polygons 26 to create and label workstations 14, while FIG. 3B shows the GUI 24 after the user overlaid polygons 26 to create and label workstations 14.

Referring first to FIG. 3A, the GUI 24 is shown in an example embodiment of the configuration setup mode after the user has chosen the “Configuration Setup” tab. In the illustrated embodiment, the GUI 24 includes a video screen 30 displaying a current video feed or frame from one of the video recording devices 18 (e.g., the first video recording device 18a in FIG. 1). The user can switch to a different video feed from another video recording device 18 using the camera selection icon 32, which enables the user to select from any video recording device 18 in the workspace that is enabled for the method 100.

FIG. 3B shows the GUI 24 after the user has placed polygons 26 to define workstation regions 28. Here, the video feed contains two workstations 14, so the user has placed a first polygon 26a at one workstation 14 to define a first workstation region 28a and a second polygon 26b at another workstation 14 to define a second workstation region 28b. To place the polygon 26, the user clicks or drags on points or lines within the video screen 30 until the polygon 26 defines the area intended to serve as the respective workstation region 28.

In the illustrated embodiment, the GUI 24 contains several icons enabling the user to easily add, remove and label workstations for use in the methods described herein. For example, the GUI 24 includes a testing country icon 36, a configuration icon 38 and a station icon 40 enabling the user to apply the appropriate labels to the current configuration. The station icon 40 enables the user to define multiple workstation regions 28 within the same video screen 30 (e.g., the first workstation region 28a and the second workstation region 28b). If there are multiple workstations in the video feed screen 30, the respective polygon 26 and/or respective workstation region 28 corresponding to the selected station can be highlighted upon selection at the station icon 40 so that the user can readily identify the polygon 26 and/or respective workstation region 28 corresponding to the selected station. The user of the GUI 24 then defines that workstation region 28 as a worker utilization configuration (e.g., a first worker utilization configuration defining a workstation region 28a as a grill station, a second worker utilization configuration defining another workstation region 28b as a fry station, etc.). These configurations can be saved for future use, so the user does not have to redraw the polygons 26 using the GUI 24 each time they perform the methods 100, 200 disclosed herein.

In the illustrated embodiment, the GUI 24 also includes a new configuration icon 42, a delete configuration icon 44, a video inferencing icon 46, a submit icon 48, a clear icon 50 and a snapshot icon 52. The new configuration icon 42 enables the user to generate a new unique configuration using the labels and polygons 26 input into the GUI 24 at that time. The delete configuration icon 44 enables the user to delete the configuration illustrated on the GUI 24 at that time. The video inferencing icon 46 enables the user to select a prerecorded video to run instead of a live video feed. The submit icon 48 enables the user to confirm and save the current configuration as a worker utilization configuration. The clear icon 50 enables the user to clear all selections and start a new worker utilization configuration. The snapshot icon 52 enables the user to refresh the view in the video screen 30 with a more recent video frame.

Referring again to FIG. 2, at step 106, the use uses the GUI 24 to configure one or more completed items stations 16. In the illustrated embodiment, the user places the GUI 24 in an order tracker configuration mode to designate how consumer items (e.g., food items) are tracked/counted. FIGS. 4A and 4B illustrate an example embodiment of the GUI 24 in the order tracker configuration mode. FIG. 4A illustrates the GUI 24 before the user has used one or more lines 60 to define when the consumer items generated at the workstation 14 are considered prepared/completed, while FIG. 3B shows the GUI 24 after the user has used one or more lines 60 to define when the consumer items generated at the workstation 14 are considered prepared/completed.

Referring first to FIG. 4A, the GUI 24 is shown in an example embodiment of the configuration setup mode after the user has chosen the “Order Tracker Config” tab. In the illustrated embodiment, the GUI 24 includes a video screen 62 displaying a current video feed or frame from one of the video recording devices 18 (e.g., the second video recording device 18b in FIG. 1). The user can switch to a different video feed from another video recording device 18 using the camera selection icon 64, which enables the user to select from any video recording device 18 in the workspace that is enabled for the method 100.

FIG. 4B shows the GUI 24 after the user placed one or more lines 60 to create and label when the consumer items generated at the workstation 14 are considered prepared/completed. Here, the user has placed a defining line 60 across an area of the video feed. The defining line 60 distinguishes an activity zone 66 from a completed zone 68. To place the defining line 60, the user clicks or drags on points or lines within the video screen 62 until the defining line 60 is placed in a location intended to designate the completed zone 68. The placement of the line 60 determines when the consumer items are counted during the method of use discussed below. The user of the GUI 24 then defines each line 60 as an order tracking configuration (e.g., a first order tracking configuration defining when sandwiches are completed, a second worker utilization configuration defining when fries are completed, etc.). The user can draw additional lines 60 for any number of additional designations in the same video feed (if any) or in other video feeds from other video recording devices 18. These order tracking configurations can be saved for future use, so the user does not have to redraw the lines 60 using the GUI 24 each time they perform the methods discussed herein.

In the illustrated embodiment, the GUI 24 contains several icons enabling the user to easily add, remove and label a defining line 60 for use in the methods described herein. For example, the GUI 24 includes a configuration icon 70 enabling the user to apply the appropriate labels to the current configuration. The GUI 24 also includes a new configuration icon 72, a delete configuration icon 74, a video inferencing icon 76, a submit icon 78, a clear icon 80 and a snapshot icon 82. The new configuration icon 72 enables the user to generate a new unique configuration using the defining line 60 input into the GUI 24 at that time. The delete configuration icon 74 enables the user to delete the configuration illustrated on the GUI 24 at that time. The video inferencing icon 76 enables the user to select a prerecorded video to run instead of a live video feed. The submit icon 78 enables the user to confirm and save the current configuration as a tracking configuration. The clear icon 80 enables the user to clear all selections and start a new tracking configuration. The snapshot icon 82 enables the user to refresh the view within the video screen 62 a more recent video frame.

Referring again to FIG. 2, at step 108, the user uses the GUI 24 in run mode to use the configurations set at steps 104 and 106. FIGS. 5A and 5B illustrate example embodiments of the GUI 24 during the run mode after the user has chosen the “Run Mode” tab. Here, the user can select a worker utilization configuration 84 from amongst the plurality of worker utilization configurations saved at step 104, and the GUI 24 will display a first video stream screen 86 of the selected worker utilization configuration(s) including the corresponding polygon(s) 26 defining the workstation region(s) 28 within the first video feed screen 86. The user can also select an order tracking configuration 88 from amongst the plurality of order tracking configurations saved at step 106, and the GUI 24 will display a second video stream screen 90 of the selected order tracking configuration(s) including the defining line(s) 60.

The user then uses the device group vest colors icons 92 on the GUI 24 to associate at least one visible identifier ID (here, vest color) with each workstation region 28 of the selected worker utilization configuration 84 shown in the first video feed screen 86. For example, the user can view the video feed screen 86 and assign the color identifier(s) ID of the team member(s) currently working at the workstation region(s) 28 defined by the polygon(s) 26. In FIG. 5A, the user has assigned the first visible identifier ID1 (black) to the first workstation 28a defined by the first polygon 26a and the second visible identifier ID2 (purple) to the second workstation 28b defined by the second polygon 26b, and the user has not assigned the third visible identifier ID3 to any workstation 28. In FIG. 5B, the user has assigned the first visible identifier ID1 (red) to the first workstation 28a defined by the first polygon 26a and the second visible identifier ID2 (white) to the second workstation 28b defined by the second polygon 26b, and the user has not assigned the third visible identifier ID3, the fourth visible identifier ID4 and the fifth visible identifier ID5 to any workstation 28. The user can also set a test number 94, run number 96 and/or a duration 98 to run the system 10 in the displayed configurations. Once all the configurations are loaded, the system 10 is configured to proceed with the method 200 discussed herein. The user can also start or stop the method 200 as needed or desired during the method 200.

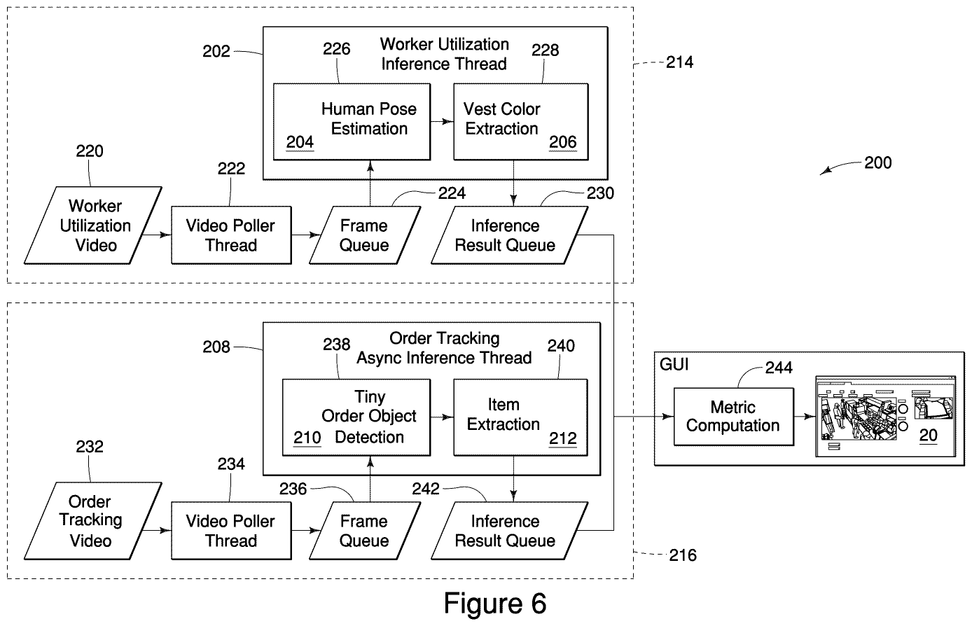

FIG. 6 illustrates an example embodiment of a method 200 of using a trained multi-tenant model with the configurations saved during the method 100 above. Those of ordinary skill in the art will recognize from this disclosure that certain steps can be added, removed or altered without departing from the spirit and scope of the method 200.

Generally summarized, the method 200 merges the results of a first asynchronous inference thread 202 that sequentially runs a human pose estimation model 204 and a clothing color extraction model 206 using successive frames from a first video feed with the results of a second asynchronous inference thread 208 that sequentially runs an object detection model 210 and an item tracking model 212 using successive frames from a second video feed. More generally, the system 10 runs a first thread 214 which includes the first asynchronous inference thread 202 and a parallel second thread 216 which includes the second asynchronous inference thread 208. The system 10 then generates a metric computation 244 using the parallel results of the first and second asynchronous inference threads 202, 208, displays real-time graphical representations GR from the metric computation 244, and/or further merges the metric computation 244 with order metrics to generate output data such as active time, percent activity and order duration, which can be used for actionable insights, testing new offering preparations and workforce adjustments. Users can gain actionable insights through inputs configured to provide multiple set points and order reference points for comparison to system data.

The steps in the method 200 are performed by a combination of the GPU 20 and the CPU 22. For example, the CPU 22 handles the thread management including management of the first thread 214 and second thread 216, while the GPU 20 receives the data needed to execute the deep learning portions of the first asynchronous inference thread 202 and the second asynchronous inference thread 208 from the CPU 22, executes the deep learning portions in those threads 202, 208, and outputs the results back to the CPU 22 for further processing.

Beginning with the first thread 214, at step 220 the CPU 22 receives a first video feed from one or more video recording devices 18 (e.g., the first video recording device 18a in FIG. 1). The first video feed generally displays an area surrounding one or more workstation 14 within the workspace 12, preferably from a generally top-left or top-right perspective angle, as seen for example in FIG. 3B. The first video feed can also display one or more of the team members wearing a visible identifier ID such as clothing of an identifying color. The first video feed has typically already been configured for use in the method 200 using the GUI 24 as described above.

At step 222, the CPU 22 extracts frames from the first video feed to create a first video poller thread. Each frame within the first video poller thread is time encoded, and can include other information as needed for different applications. The first video poller thread is configured to poll the first video asynchronously to minimize latency while running the human pose estimation model 204 and the clothing color extraction model 206. The first video poller thread enables parallel processing by allowing the GPU 20 and the CPU 22 to handle multiple frames simultaneously. This improves the overall efficiency and speed of the system 10.

At step 224, the CPU 22 places the extracted and time encoded frames from the first video poller thread of step 222 into a first frame input queue used by the GPU 20 to run inferences via the first asynchronous inference thread 202. The first frame input queue stores at least the two most recent frames of the first video feed, making the frames ready for immediate use by the human pose estimation model 204 and the clothing color extraction model 206. The first frame input queue enables the GPU 20 to pull the frames instead of waiting for data to be received from the video recording devices 18. The frames can be resized from their original resolution and stored as RGB pixel data in the first frame input queue. The size of the frames and the input queue can be adjusted between uses as needed.

At step 226, the GPU 20 pulls the frames from the first frame input queue and executes a first deep learning application. The first deep learning application is a human pose estimation model 204 that detects human objects in each sequential video frame and estimates the pose of any detected human objects. The human pose estimation model 204 uses the estimated pose of each human object with respect to the user-delineated workstation regions 28 and determines whether they are actively working at the workstation 14. More specifically, the human pose estimation model 204 detects a bounding box of each human object and the pixel locations of each joint in the detected human object's pose. The pose estimation model 204 then determines whether the detected human object sufficiently crosses into the corresponding workstation region 28. In the illustrated embodiment, the human pose estimation model 204 determines the team member to be active when the point vector for that team member shows hands or elbows intersecting with the defined workstation region 28. In alternative embodiments, the GPU 20 is configured so that other parts besides or in addition to hands and elbows need to be located within the workstation region 28 for the team member to be considered active. In an embodiment, the human pose estimation model 204 includes a single-shot Convolutional Neural Network model to minimize latency.

In an embodiment, the GPU 20 can further implement logic to mitigate momentary periods of inactivity when a team member briefly leaves a workstation 14. Active and idle times can be calculated, saved and delivered upon completion of the method 200. In an embodiment, active and idle times are computed based on when a hand or elbow is detected inside or outside of workstation region 28 defined during the configuration method 100 discussed above. FIG. 5B illustrates an example embodiment of a graphical representation GR including an active percentage determined form active/idle times.

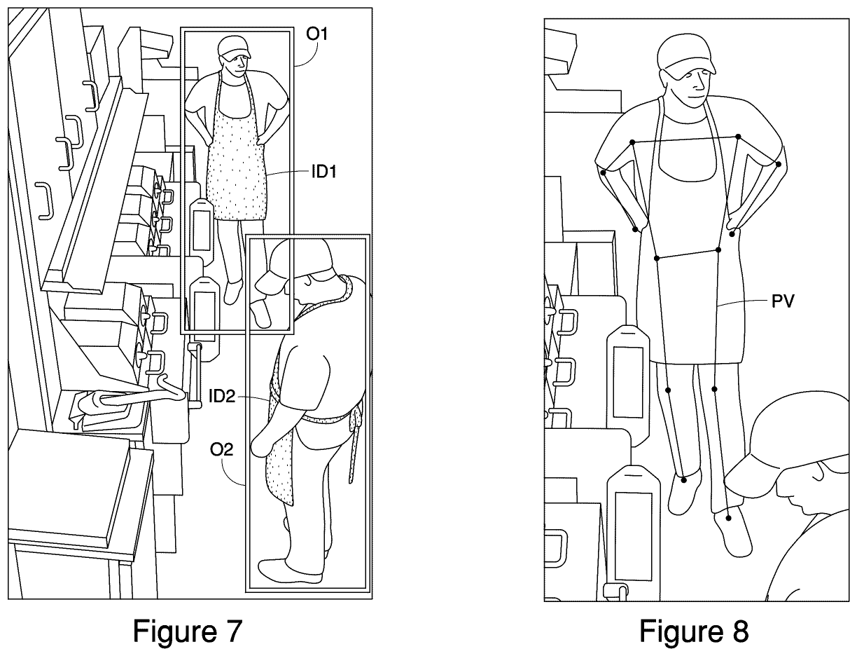

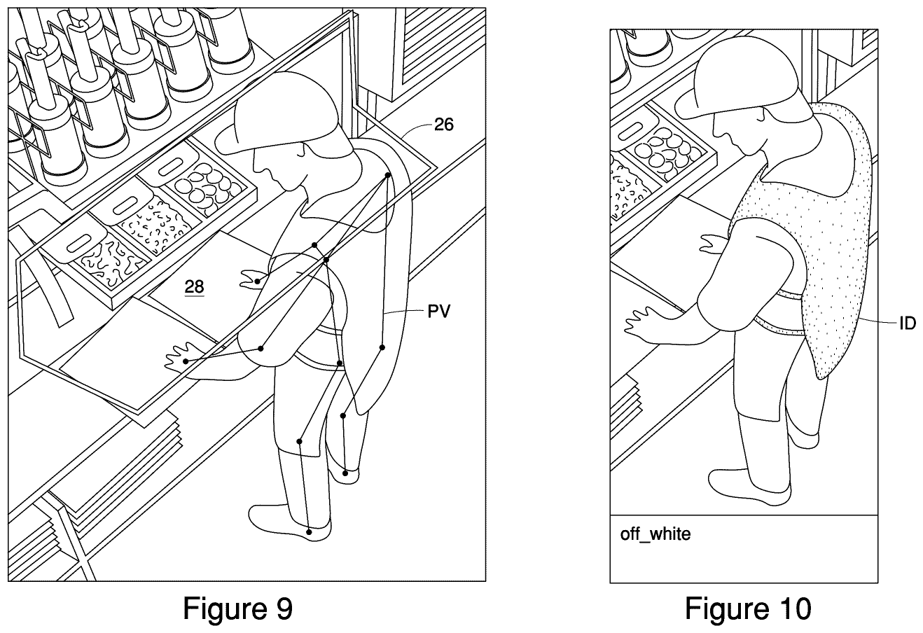

FIGS. 7 to 9 illustrate example embodiments of the human object detection and human pose estimation performed by the human pose estimation model 204. In FIG. 7, the human pose estimation model 204 detects two human objects in the video frame. The human objects are identified by the bounding boxes O1, O2 wearing visible identifiers ID1, ID2. The human pose estimation model 204 then estimates the pose for each of the detected human objects O1, O2 using point vectors PV. FIG. 8 illustrates an example of the human pose estimation model 204 estimating the pose of the detected human object O1 in the frame from FIG. 7 by creating a human pose point vector PV. The point vector PV for the detected human object in FIG. 8 does not have hands or arms that cross into a workstation region 28, so the detected human object is not considered active in the frame. On the other hand, in FIG. 9, the point vector PV for the detected human object shows hands and arms intersecting the boundary of the polygon 26 defining the workstation region 28 and extending into the workstation region 28. The GPU 20 would therefore determine that the detected human in FIG. 9 is active in the workstation region 28.

At step 228, the GPU 20 executes a second deep learning application. The second deep learning application is a color extraction model 206 designed for image classification tasks. For each frame, the color extraction model 206 extracts color from each human object that has already been determined to be active in the frame by the human pose estimation model 204. The color extraction model 206 extracts the clothing color of each active human object to determine whether the active team member is the team member assigned to the workstation 14 corresponding workstation region 28. In the illustrated embodiment, the color extraction model 206 uses the bounding box boxes O1, O2 created by the human pose estimation model 204 to determine where to extract or not extract color from a frame. In an embodiment, human pose estimation model 204 only needs to process a frame if the human pose estimation model 204 has determined that a human object is active in the frame.

The identification of the color vest as disclosed herein is advantageous because it requires only a small classifier as opposed to a larger and less reliable re-identification model. In an embodiment, the second deep learning application includes a deep classification Convolutional Neural Network, which can be composed of multiple layers that learn to recognize patterns and features in images, enabling classification of objects with high accuracy.

FIGS. 9 and 10 illustrate an example embodiment of the color extraction performed by the color extraction model 206. As seen in FIG. 9, a human object is active within a workstation region 28, as determined by the human pose estimation model 204 using the point vector PV and the polygon 26. In FIG. 10, the color extraction model 206 extracts color from the identifier ID for the active human object. The identification of the color (here, off-white) by the clothing color extraction model 206 determines whether the human object active in the workstation region 28 is the team member that has been assigned to the workstation 14 corresponding to that workstation region 28. The team member shown in FIG. 10 can be assigned a visible identifier ID and matched to detections in successive frames.

By setting up the first asynchronous inference thread 202 as shown and described herein, the human pose estimation model 204 and the color extraction model 206 can operate simultaneously. That is, the human pose estimation model 204 begins processing a next sequential frame (e.g., n+1 frame) while the color extraction model 206 processes a current frame (e.g., n frame). This way, the arrangement saves memory and solves several technological problems by optimizing the use of computational resources in a multi-tenant model. This enables a higher frame processing rate, which is important when objects are being tracked between frames, as they are in the kitchen production tracking time model. Additionally, it provides a higher resolution of active vs idle time by enabling a higher throughput of frames.

At step 230, the CPU 22 builds a worker utilization inference result queue using the inferences made by the first asynchronous inference thread 202. The inference result queue is a sequential (first-in, first-out) queue that processes requests in the order they arrive. For each frame, the GPU 20 identifies whether a team member with the assigned identifier ID is active within each workstation region 28 at each point in time. That is, the worker utilization inference results indicate the activity status of team members based on their point vectors PV showing key points (e.g., hands/elbows) within the defined workstation zones 28. Each frame can store the detected objects, poses, and vest colors (if applicable). The inference result queue is stored on the CPU 22.

More than one team member can be active or inactive at each point in time since each team member is wearing a distinct identifier ID. Each identifier ID is assigned a workstation region 28, and only the team member wearing that distinct identifier ID can activate that workstation region 28 by moving their key points (e.g., hands/elbows) within the workstation region 28. For example, if two team members are working on two grills, one wearing a black color vest and the other wearing a red color vest, each color can be assigned to their specific grill. Each workstation 14 is only considered active when the team member wearing the assigned identifier ID enters that workstation region 28 with their hands or elbows.

Referring now to the second thread 216 which runs parallel to the first thread 214, at step 232 the CPU 22 receives a second video feed from one or more video recording devices 18 (e.g., the second video recording device 18b in FIG. 2). The second video feed generally displays an overhead view of one or more completed item stations 16 to capture items (e.g., food items) coming through the production line into a point of completion, as seen for example in FIGS. 4A and 4B. The second video feed has typically already been configured for use in the method 200 as described above using the GUI 24.

At step 234, the CPU 22 extracts frames from the second video feed to create a second video poller thread. Each frame within the second video poller thread is time encoded, and can include other information as needed for different applications. The second video poller thread is configured to poll the second video asynchronously to minimize latency while running the object detection model 210 and the item tracking model 212. The second video poller thread enables parallel processing by allowing the GPU 20 and the CPU 22 to handle multiple frames simultaneously. This improves the overall efficiency and speed of the system 10.

At step 236, the CPU 22 places the extracted and time encoded frames from the second video poller thread of step 234 into a second frame input queue used by the GPU 20 to run inferences via the second asynchronous inference thread 208. The second frame input queue stores at least the two most recent frames of the second video feed, making the frames ready for immediate use by the object detection model 210 and the item tracking model 212. The second frame input queue enables the GPU 20 to pull the frames instead of waiting for data to be received from the video recording devices 18. The frames can be resized from their original resolution and stored as RGB pixel data in the second frame input queue. The size of the frames and the input queue can be adjusted between uses as needed.

At step 238, the GPU 20 pulls the frames from the second frame input queue and executes a third deep learning application. The third deep learning application is an object detection model 210 that detects tiny objects in each sequential video frame in the second frame input queue. In the restaurant example used herein, the tiny objects can be sandwiches, fries, etc.

At step 240, the CPU 22 determines whether the objects detected by the object detection model 210 have crossed the defined line 60 (e.g., as seen in FIGS. 4B, 5A and 5B). More specifically, the CPU 22 runs an item tracking model 212 the tracks objects across multiple frames in the second video stream using a Kalman filter to associate detection between two sequential video frames. The item tracking model 212 uses the overlap of detections between frames to identify the same objects in different frames and determine that an object has passed the defined line 60 such that it is considered prepared/completed. When the detected objects cross the line 60 into the completed region 68, the objects are considered prepared/completed and the timestamp is stored.

At step 242, the CPU 22 builds an order tracking inference result queue using the successive frames from the second video feed. The order tracking inference result queue is a sequential (first-in, first-out) queue that processes requests in the order they arrive. Each frame stores the identified objects with an associated object ID. The order tracking inference results indicate the number of a particular type of consumer item that has been completed by one or more workstation 14.

At step 244, the CPU 22 merges the worker utilization inference result queue and the order tracking inference result queue using the encoded timestamps for the video frames. In an embodiment, the CPU 22 uses the queues to perform a metric computation which can be used for actionable insights. The metric computation can include, for example, active/idle time and average order prep duration at each workstation 14 for the duration 46 input into the GUI 20, as seen for example in FIG. 5B. The CPU 22 can also generate one or more real-time graphical representations GR of the metric computations, as also seen for example in FIG. 5B.

The CPU 22 also is also configured to receive customer order data determined from orders placed by customers. The customer order data can include timestamps, types of service channels, and/or items included in the customer orders. For example, the customer order data can include timestamped data created during the process of receiving and delivering each customer order, for example, when the customer placed an order, when the customer paid for the order, and/or when the business presented the completed order to the customer. The customer order data can also include a type of service channels that the order was placed or provided, for example, online, over the telephone, at a drive thru, curbside, at a front counter, at table service, at a kiosk or otherwise. The customer order data can further include what items were included in the order, for example, sandwiches, chicken nuggets, fries, etc. In an embodiment, the CPU 22 can receive a data stream regarding point-of-service orders such as sandwiches, fries, etc.

The CPU 22 is also configured to merge the customer order data with the order tracking inference results from step 244, for example, using timestamps included in each data set. In an embodiment, the CPU 22 includes an algorithm that matches received order timestamps to timestamps of completed items as they pass into completed item stations 16. The timestamps can be matched such that they fit into a minimum and maximum order time. The CPU 22 is also be configured to output data such as actionable insights, active time, percent activity and/or order duration. For example, the CPU 22 is configured to determine the timestamp from the order initiation point extracted from point-of-service data, and then to further determine an elapsed time until the order (e.g., a sandwich) moves from a workstation 14 (e.g., the prep table) to a packing station and then crosses the defined line 60 determining completion. The CPU 22 is also be configured to calculate the average time per order to help understand inefficiencies in the prep line.

The embodiments described herein provide improved systems and methods for implementing a trained multi-tenant model using a combination of pose estimation and clothing color classification. It should be understood that various changes and modifications to the systems and methods described herein will be apparent to those skilled in the art and can be made without diminishing the intended advantages.

### General Interpretation of Terms

In understanding the scope of the present invention, the term “comprising” and its derivatives, as used herein, are intended to be open-ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” or “element” when used in the singular can have the dual meaning of a single part or a plurality of parts.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A method of using a trained multi-tenant model in a workspace, the method comprising:
receiving a first video feed including a workstation and a second video feed including a completed item station;
building a worker utilization inference result queue from a first asynchronous inference thread that runs a human pose estimation model and a clothing color extraction model using sequential frames from the first video feed;
building an order tracking inference result queue from a second asynchronous inference thread that runs an object detection model and an item tracking model using sequential frames from the second video feed; and
merging the worker utilization inference result queue and the order tracking inference result queue to generate a real-time indication of activity at one or more workstations shown in the first video feed or the second video feed.

2. The method of claim 1, comprising
designating a workstation region within the first video feed by defining a polygon using a graphical user interface displaying the first video feed.

3. The method of claim 2, comprising
designating a team member having a first clothing color for the designated workstation region.

4. The method of claim 1, comprising
designating a line within the second video feed defining when consumer items generated at the workstation are considered completed.

5. The method of claim 1, comprising
merging the worker utilization inference result queue and the order tracking inference result queue using timestamps for the entries in each queue.

6. The method of claim 1, wherein
the worker utilization inference result queue includes, for each of a plurality of frames from the first video feed, at least a timestamp and an indication of whether a team member having an assigned color is active within a workstation zone.

7. The method of claim 1, wherein
the order tracking inference result queue includes, for each of a plurality of frames from the second video feed, at least a timestamp and an indication of one or more consumer items crossing a defined line.

8. A method of configuring a trained multi-tenant model for a particular workspace, the method comprising:
receiving a first video feed of at least one workstation;
enabling a user to designate a workstation region within the first video feed using a polygon;
enabling the user to assign a visual identifier to the workstation region;
detecting a human object in each of a plurality of frames of the first video feed;
determining whether a pose of the human object extends into the workstation region in each of the plurality of frames of the first video feed;
extracting a color of the human object in each of the plurality of frames of the first video feed; and
determining an activity level in the first video feed based on the human object extending into the workstation region and the extracted color.

9. The method of claim 8, comprising
extracting each of the frames of the first video feed into a first input queue,
building a worker utilization inference result queue from a first asynchronous inference thread that runs a human pose estimation model and a clothing color extraction model using sequential frames from the first input queue.

10. The method of claim 8, comprising
receiving a second video feed of at least one completed item station,
enabling the user to define a line that determines when consumer items are considered completed,
detecting objects at the completed item station in each of a plurality of frames of the second video feed,
determining whether the objects cross the defined line in each of a plurality of frames of the second video feed, and
determining the activity level using a number of objects that cross the defined line.

11. The method of claim 10, comprising
extracting each of the frames of the second video feed into a second input queue,
building an order tracking inference result queue from a second asynchronous inference thread that runs an object detection model using sequential frames from the second input queue.

12. The method of claim 11, comprising
building a worker utilization inference result queue from a first asynchronous inference thread that runs a human pose estimation model and a clothing color extraction model using successive frames from a first input queue, and
merging the worker utilization inference result queue and the order tracking inference result queue to determine the activity level at one or more workstations shown in the first video feed or the second video feed.

13. The method of claim 10, comprising
generating a graphical user interface showing the second video feed and enabling the user to define the line that determines when consumer items are considered completed by overlaying the line on one or more frames of the second video feed.

14. The method of claim 8, comprising
generating a graphical user interface showing the first video feed and enabling the user to designate the workstation region by overlaying the polygon on one or more frames of the first video feed.

15. A system for using a trained multi-tenant model in a workplace, the system comprising:
at least one video feed of a workplace from at least one video recording device;
a graphical user interface configured to (i) enable a user to designate a workstation region within the at least one video feed using a polygon, (ii) enable the user to designate a line within the at least one video feed which defines when consumer items are considered completed, and (iii) enable the user to assign a clothing color of a team member to the workstation zone;
a graphical processing unit configured to generate results for (a) a first inference result queue storing data regarding whether the team member with the designate clothing color uses a pose crossing into the designated workstation region in a plurality of sequential frames of the at least one video feed, and (b) a second inference result queue storing data regarding whether consumer items cross the defined line in a plurality of sequential frames of the at least one video feed; and
a computer processing unit configured to merge the first inference result queue and the second inference result queue and generate a real-time indication based thereon.

16. The system of claim 15, wherein
the graphical user interface is configured to enable a user to designate a plurality of different workstation regions within a same video feed using a plurality of polygons.

17. The system of claim 15, wherein
the graphical user interface is configured to enable a user to designate a plurality of different workstation regions within different video feeds using a plurality of polygons.

18. The system of claim 15, wherein
the graphical processing unit is configured to run a pose estimation model and a color extraction model to generate results for the first inference result queue.

19. The system of claim 15, wherein
the graphical processing unit includes a first deep learning application configured determine a pose of a detected human object in the at least one video feed and a second deep learning application configured to determine a color of the detected object in the at least one video feed, the graphical processing unit generating results for each frame in the first inference result queue using both the first deep learning application and the second deep learning application.

20. The system of claim 19, wherein
the graphical processing unit includes a third deep learning application configured to detect customer items at the workstation to enable an item tracking model to determine when each of the consumer items crossed the defined line.
